(19) United States
(12) Patent Application Publication
(10) Pub. No.: US 2002/0022019 A1
(43) Pub. Date: Feb. 21, 2002

(54) Method of reducing ecologically adverse changes of the gastro intestinal microbial flora in patients under treatment with medicaments

(76) Inventor: Svend Laulund, Birkerod (DK)

Correspondence Address: Stanislaus Aksman, Hunton & Williams, Suite 1200, 1900 K Street, N.W., Washington, DC, 20006, US

(21) Appl. No.: 09/905,961

(22) Filed: Jul. 17, 2001

Related U.S. Application Data
(60) Provisional application No. 60/218,526, filed on Jul. 17, 2000.

(30) Foreign Application Priority Data
Jul. 17, 2000 (DK) DK PA2000 01106

(51) Int. Cl. A01N 63/00; A01N 63/04; A01N 65/00

(52) U.S. Cl. 424/93.45; 424/93.4; 424/93.5; 424/93.51

(57) ABSTRACT

A method for reducing ecologically adverse changes of the gastrointestinal micro-flora in patients under treatment with medicaments (which may also be referred to herein as the therapeutic compounds or medications) such as gastric acid reducing medicaments or antibiotics. A pharmaceutical product useful in the present method comprising a medicament and a probiotically active organism as a combined preparation presented in a commercial package unit.

### FIELD OF INVENTION

The present invention relates to the field of maintaining a balanced microbial flora in the gastrointestinal (GI) tract. In particular a method is provided for reducing ecologically adverse changes of the gastrointestinal micro-flora in patients under treatment with medicaments and specifically a pharmaceutical product comprising a medicament is provided and one or more probiotically active organisms as a combined preparation presented in a commercial package unit.

### TECHNICAL BACKGROUND AND PRIOR ART

The animal GI micro-flora is under normal circumstances a stable ecosystem where the composition of the microbial flora and pH remain relatively constant in the various segments of the GI. This ecological system is created by the indigenous micro-organisms and the host providing a number of favourable habitats for microbial growth. The stomach is acidic and only a few acid tolerant organisms, such as Lactobacillus, are able to live and grow. The intestinal tract is neutral to alkaline in pH and is thus a major site for bacterial growth. Due to a neutral pH in the large intestine, bacteria are present in vast number in this GI segment. The characteristic micro-flora of the large intestine consists mainly of anaerobic bacteria such as Bifidobacterium, Streptococcus and Lactobacillus or the obligate anaerobes Clostridium and Bacterioides, but also facultative aerobes such as Escherichia coil are present in smaller numbers.

One of the most important effects of this ecosystem is the maintenance of the colonisation resistance against potentially pathogenic micro-organisms. Bacterial interference plays a key role for the colonisation resistance, and production of volatile fatty acids and bacteriocins and mutual competition for attachment sites and nutrients tales place, which contributes to a defence against pathogenic micro-organisms.

This important, but vulnerable balance of the ecosystem of the gastrointestinal tract can be altered by certain factors such as anti-microbial therapy, gastric acid reducing medicaments, diet, environment, pathologic conditions and surgery of the gastrointestinal tract. In the absence of a normally balanced flora the environmental conditions in the GI, e.g. pH and atmospheric conditions changes in the large intestines and there may develop established opportunistic populations or colonies of pathogenic micro-organisms such as e.g. Staphylococcus, Escherichia, Champhylobacter, Candida or Samonella species which usually under normal conditions do not live or grow in the GI tract as they can not compete for survival in the environment of the normal microbial flora. The consequence hereof is frequently an overgrowth of pathogens which may imply unpleasant or pathogenic conditions, such as diarrhoea, abdominal pain, vomiting and/or nausea.

One of the most common and significant causes of disturbance of the microbial flora in e.g. GI is a consequence of the administration of anti-microbial agents such as e.g. antibiotics for the treatment of numerous disorders and infectious diseases. Suppression of the endogenous microbial flora during antibiotic therapy reduces the colonisation resistance and leads to undesired adverse effects such as proliferation and overgrowth of potentially pathogenic micro-organisms and may e.g. give rise to antibiotically associated diarrhoea. Anti-microbial agents such as e.g. cephalosporins, clindamycin and ampicillin have been associated with such disease in the medical literature (Fekety, 1968, Smith, 1975).

Other factors adversely affecting the function of the GI system in the animal compise chronic disorders of the upper GI tract and the general categories of gastritis and peptic ulcer disease. Gastritis is characterised by an inflammation of the stomach mucosa due to an increased production of gastric acid. Peptic ulcers are lesions of the gastrointestinal tract lining characterised by loss of tissue due to the action of digestive acids and pepsin. It has been generally held that peptic ulcers are caused either by gastric hypersecretion or by decreased resistance of the gastric lining to digestive acids and pepsin.

The medical literature describes several methods for treating ulcers, such as e.g. modification of the diet, surgical removal of the lesions, and the use of medicaments. Such medicaments include: antacids, which serve to counteract an excess of gastric secretion of acid; anticholinergic compounds, which reduce acid secretion; histamine H₂ receptor blocking agents, which also block the release of gastric acids; proton-pump inhibiting compounds; prostaglandins, which increase the resistance of the gastric lining to digestive fluid and which may also inhibit acid secretion; prokinetic agents enhancing GI tract motility; and compositions which form protective barriers over gastric lesions. The disadvantage of secretion inhibition is that micro-organisms, which do not survive in the normal stomach environment, to a high degree do survive and proliferate upon administration of acid secretion inhibitors in the stomach and the small intestine. As a consequence hereof, the ingestion of acid secretion inhibitors often gives rise to bacterial and/or parasitic infections in the intestine. A general description of medicaments and therapies for treating gastrointestinal disorders are e.g. provided in “The Merck Manual of Diagnosis and Therapy” 5th edition (1987), Chapter 54.

Thus, whereas the above gastric acid-reducing agents have demonstrated effectiveness in treating some gastrointestinal disorders, their efficacy is questioned in light of the infections and disorders associated with their use, e.g. high relapse rate associated with cimetidine treatment of gastric ulcers (McLean et al., 1984). As a consequence hereof, patients treated with such medicine suffer from having potentially higher risk of infection in their GI caused by e.g. Camphylobacter and Samonella as the barrier function of their normal flora of the GI has been weakened and thus is not able to resist the activity and competitiveness of present pathogenic organisms (Marshall & Warren, 1984). The outcome hereof becomes unpleasant adverse effects such as proliferation and overgrowth of the potentially pathogenic micro-organisms and may e.g. cause infectious diarrhoea and diarrhoea associated with gastric acid-reducing medicaments.

Treatment of gastrointestinal disorders with agents having anti-microbial effects, is known in the art. For example, ulcer medicine such as bismuth subcitrate (De Nol®; Gist-Brocades, N.V.) is used as an anti-secretory agent and an anti-microbial agent having activity against pathogenic micro-flora such as e.g. Camphylobacter pyloridis and Heliobacter pylori. However, the host resistance is not active during this treatment, nor is a barrier developed against pathogenic micro-organisms.

However, the present inventors have to their surprise found that by combined administration of a medicament for treatment of gastrointestinal disorders and one or more probiotically active organisms, each probiotical organism acts as a barrier for pathogens and activation of the host resistance takes place and is retained during treatment with medicaments causing adverse effects on the microbial flora in the GI, whereby the occurrence of ecologically adverse changes of the microbial flora in patients under treatment with said medicaments appears to be effectively controlled. The present invention has been accomplished on the basis of this finding.

The expression “probiotically active organisms” designates a class of micro-organisms which is defined as a microbial food or feed supplement which beneficially affects the host animal by improving its gastrointestinal microbial balance. The known beneficial effects include improvement of the colonisation resistance against the harmful micro-flora due to oxygen consumption and acid production of the probiotic organisms. An example of the efficacy of probiotically active organisms to prevent overgrowth of potential pathogens and thus diarrhoea, is shown in a study where the administration of capsules containing viable probiotically active organisms to tourists travelling in Egypt resulted in a protection rate of 39,4% against traveller's diarrhoea (Black et al. 1989). A review of probiotics and their effects in man and animals can be found in Fuller, 1989 and 1994.

Fermented dairy products or capsules containing viable lactic acid bacteria having probiotic activity, such as Lactobacillus and Bifidobacterium species, have been used in connection with the administration of antibiotics in order to re-establish the GI microbial flora in patients undergoing treatment with antibiotics (Black et al. 1991, Gotz et al. 1979, Orrhage et al. 1994, Salminen et al. 1989). These studies show that the re-establishment of the ecological balance in the gastrointestinal tract after an antibiotic therapy was faster in the group of patients receiving lactic acid bacterial-supplement than patient not receiving such a supplement.

Although there may be a broad range of methods and commercial products for treating gastrointestinal disorders associated with the use of medicaments there is still a considerable clinical need to identify new solutions and products which are convenient and ready to use for patients undergoing GI treatment with medicaments in order to re-establish and/or maintain the gastrointestinal micro-flora that is normally present in a healthy subject.

Whereas, as noted hereinbefore, medicaments for treatment of GI disorders, such as antimicrobial and gastric acid-reducing agents, and compositions of probiotically active organisms are individually known as such, the present invention provides the medicament and the probiotically active organism as a convenient combined preparation for simultaneous, separate or sequential use for reducing the occurrence of ecologically adverse changes of the intestinal microbial flora. Thus, the present invention provides a commercial package unit containing both the medicament and the probiotically active organism, which is convenient for the patient as the combination composition makes it possible to purchase the medicament and the probiotically active organism at the same time in one package with adjusted and coordinated dosages.

### SUMMARY OF THE INVENTION

The present invention provides in a first aspect a method of reducing the occurrence of an ecologically adverse change of the composition of the microbial flora in an animal caused by treatment with a medicament, the method comprising administering, in association with the administration of the medicament, an effective amount of one or more probiotically active organisms in the form of a product comprising said medicament and the probiotically active organism or organisms as a combined preparation for simultaneous, separate or sequential use for reducing the occurrence of said ecologically adverse changes of the microbial flora.

In another aspect, a method is provided to reduce the occurrence of an ecologically adverse change of the composition of the microbial flora in an animal caused by treatment with a gastric acid-reducing medicament, the method comprising administering, in association with the administration of said medicament an effective amount of one or more probiotically active organisms.

In a further aspect, the invention pertains to the use of one or more probiotically active organisms in the manufacturing of a product for use in a method of reducing the occurrence of an ecologically adverse change of the composition of the microbial flora in an animal caused by treatment with a medicament, said method comprising administering, in association with the administration of the medicament an effective amount of the probiotically active organism, the product comprising said medicament and the probiotically active organism as a combined preparation for simultaneous, separate or sequential use for reducing the occurrence of said ecologically adverse changes of the microbial flora.

In a still further aspect, the invention provides a product comprising a medicament and one or more probiotically active organisms as a combined preparation for simultaneous, separate or sequential use for reducing the occurrence of ecologically adverse changes of the microbial flora in an animal caused by treatment with the medicament.

### DETAILED DISCLOSURE OF THE INVENTION

It is the primary objective of the present invention to provide a generally applicable method for reducing the occurrence of ecologically adverse changes of the microbial flora in patients undergoing gastrointestinal treatments with medicaments by using a product comprising the medicament and the probiotically active organism optionally as a combined preparation.

In the present context, the expression “a product comprising the medicament and the probiotically active organism as a combined preparation” refers to a commercial product wherein the medicament and the probiotically active organism are present together in a commercial package unit and which can be administered simultaneously, separately or at intervals to the same patient. The definition encompasses that the medicament and the probiotic are provided together in one package. The definition does not relate to the situation where the probiotic contained exclusively in a package is purchased in association with the purchased of a medicament causing ecological adverse changes of the intestinal micro-flora. Thus, the commercial package unit may be e.g. a pack such as a multiple (e.g. twin) pack or a dispenser device. The pack may optionally comprise e.g. metal or plastic foil, such as a blister pack.

The expression “combined preparation” relates to the form in which the medicament and the probiotic are presented in the product. Thus, the medicament and the probiotic can be provided separately as a kits-of-parts, i.e. separate pharmaceutical compositions, or as a single pharmaceutical composition, i.e. where the medicament and the probiotic are e.g. provided as a mixture or provided separately in independently sub-capsules within one capsules. However, as described in detail below, the medicament and the probiotically active organism may conveniently be provided in the conventional manner. Thus, the medicament and/or probiotically active organism may be formulated as a tablet (including chewable tablets), a capsule (of either the hard or soft type), a powder, a granulate or as a liquid preparation.

Thus, in its broadest aspect the present invention provides a method of reducing the occurrence of an ecologically adverse change of the composition of the GI microbial flora in an animal caused by treatment with a medicament, the method comprising administering, in association with the administration of the medicament an effective amount of a probiotically active organism in the form of a product comprising the medicament and the probiotically active organism as a combined preparation for simultaneous, separate or sequential use for reducing the occurrence of said ecologically adverse changes of the microbial flora.

As used herein, the expression “ecologically adverse change of the composition of the microbial flora in an animal” relates primarily to a change, i.e. a decrease or increase, in total numbers of the indigenous micro-flora or a change, i.e. a shift in balance between individual species, in the number of individual species in the GI tract of an animal. However, the definition also encompasses the results of the number of the indigenous microflora, namely overgrowth of micro-organism present that are resistant to the medicament administered, or to the development of new resistant strains, such as antibiotic resistant pathogenic strains. The term “animal” relates to vertebrates both human and animals including fish, birds such as poultry, turkey and ostrich, and mammals such as cattle, pigs, buffaloes, camels, deer, antelopes, giraffes, sheep, goats, horse, donkey, elephant, monkey and chimpanzee.

In the present context, the expression “reducing the occurrence” indicates that the above-mentioned typical adverse effects or symptoms from the administration of medicaments to the gastrointestinal tract occurs to a reduced extent as compared to a patient not being treated according to the method of the invention.

The term “medicament” is used herein in the conventional meaning of the term i.e. a pharmaceutically active substance or mixture of chemical or natural compounds for preventing, diagnosing, alleviating and/or curing disease. In accordance with the present invention, such medicaments include e.g. gastric acid reducing agents, anti-microbial agents or compounds that have a regulatory effect on the digestion or any other known agent or medicament which has an impact on the composition of the normal micro-flora of the gastrointestinal tract. The terms “gastrointestinal tract” or “intestinal” are used interchangeably and relates to both the upper and lower gastrointestinal tract which includes the esophagus, the stomach, the small intestines consisting of the duodenum, the jejunum and the ileum, and the large intestines comprising colon and caecum.

The term “administration”, as used herein, refers to any method which, in sound medical practice, delivers the medicament and the probiotically active organism to the subject to be treated such as to be effective in treating the disease to be treated and reducing changes of the composition of the normal micro-flora of the gastrointestinal tract. The medicament and the probiotically active organism may be preferably administrated orally, although the medicament, where appropriate, may also be administrated intravenously, intramuscularly or subcutaneously.

In accordance with the method of the invention, the administration of the combined preparation may occur simultaneously, separately or sequentially for reducing the occurrence of said ecologically adverse changes of the microbial flora. The term “simultaneously” relates to the incidence where the medicament and the probiotically active organism are administrated substantially at the same time to a patient either in form of a separate or single preparation. The term “separately” is used in the present context to indicate the incidence where the medicament and the probiotically active organism are administrated separately within only a short period, such as 1, 2, 3, 4 or 5 minutes. The term “sequentially” relates to the administration of the medicament and the probiotically active organism at specific intervals, such as intervals at 5, 10, 15, 20, 25 or 30 minutes. It will be understood, that the definitions “simultaneously”, “separately” and “sequentially” encompasses both the incidence where the medicament is administrated before the probiotically active organism and vica versa.

In the present context, the expressions “probiotically active organism” and “probiotics” are used interchangeably and defines a class of micro-organisms which, when ingested in the form of viable cells by humans or animals, confers an improved health condition, e.g. by improving or stabilising the intestinal microbial balance, suppressing harmful micro- organisms in the gastrointestinal tract, enhancing the immune system or contributing to the digestion of nutrients. In accordance with the invention, such probiotics are administered in an effective amount in association with a medicament causing ecologically adverse changes of the intestinal micro-flora. As used herein the term “an effective amount” relates to an amount of probiotically active organisms, which when it is administrated in association with the medicament is sufficient to obtain the desired reduction of occurrence of the ecologically adverse changes of the microbial flora during medical therapy.

As mentioned above, the change in the intestinal micro-flora caused by medical therapy can cause infectious disease and diarrhoea which is caused by organisms such as e.g. Heliobacter pylori, Camphylobacter pyloridis, Staphylococcus aureus, Staphylococcus epidermidis, Streptococcus pyogenes, Streptococcus pneumoniae, Enterococcus faecalis, Hemophilus influenzae, Escherichia coli, Klebsiella pneumoniae, Enterobacter cloacae, Citrobacter freundii, Serratia marcescens, Pseudomonas aeruginosa and Pseudomonas maltophilia, Salmonella sp. and fungi such as Candida albicans and Aspergillus fumigatus, and combinations of these species. Additionally, in recent years rotavirus and other enteric virus have been identified as a major cause of infectious diarrhoea and diarrhoea associated with antibiotic therapy.

It has been surprisingly found by the present inventors that the occurrence of an ecologically adverse change of the intestinal micro-flora caused by gastric acid-reducing agents can successfully be reduced when a probiotically active organism is administered in association with the acid reducing-agent. Thus, in one useful embodiment of the method according to the invention, the medicament causing the ecologically adverse change of the composition of the microbial flora is a gastric acid-reducing medicament. As discussed above, such gastric acid-reducing medicaments include antacids, histamine H₂ receptor blocking agents, anticholinergic compounds, proton pump inhibiting compounds and prostaglandins. Commercial products for reducing the gastric acid which are useful in the present method include e.g. Alkasid® LEO, Alminox® “Dak” NYCOMED DANMARK, Balancid® Novum® ASTRAZENECA, Link® ALPHARMA, Magnesia “Dak” NYCOMED DANMARK, Noacid® OBA, Novaluzid® ASTRAZENECA, Egazil Duretter® ASTRAZENECA, Buscopan® BOEHRINGER INGELHEIM, Aciloc® ORION PHARMA, Acinil® GEA, Aducin® NETTOPHARMA, Cimecodan PHARMACODANE, Cimetidin “NM” GERARD, Hocimin® DURASCAN, Kuracid® GEA, Nizax® LILLY, Novamet SMITHKLINE BEECHAM, Pepcidin® MSD, Ranicodan PHARMACODANE, Ranikur OPCO, Ranitidin “NM” NM PHARMA, Tagamet® SMITHKLINE BEECHAM, Zantac® GLAXO WELLCOME, Lanzo® WYETH LEDERLE, Losec® ASTRAZENECA, Pantoloc® BYK GULDEN, Pariet® JANSSEN-CILAG, Antepsin® ORION PHARMA, Hexagastron® DURASCAN, Cytotec® SEARLE and De Nol® YAMANOUCHI PHARMA.

In one further embodiment of the present method, the medicament causing the ecologically adverse change of the composition of the microbial flora is an anti-microbial agent. Such anti-microbial agents can be e.g. selected from the group consisting of a β-lactam, a penicillin, a cefalosporine, a monobactame, a carbapeneme, a macrolidantibiotic, a polymyxin, a tetracycline, a chloramphenicol, a aminoglycosid, a fluorquinolone, fusidin, clindamycin, teicoplanin, vancomycin and rifampicin.

In a specific embodiment, the medicament causing the ecologically adverse change of the composition of the microbial flora is a compound that has a regulatory effect on the digestion such as preparations of digestive enzymes and digestives.

There is a range of probiotically active microorganisms which are suitable for use in this invention including fungal species, yeast species and bacterial species. Examples of currently useful filamentous fungi include e.g. Debaryomyces species such as Debaryomyces hansenii, Geotrichum candidum, Torula kefir, Endothia parasitica, Candida valida, Pichia species, Torulopsis species, Kluyveromyces species such as Kluyveromyces maxianus and Kluyveromyces thermotolerans, Torelospora species such as Torelospora delbrueckii, Ogtsea species and Trametes species, Aspergillus species, Rhizopus species, Mucor species, Penicillium species such as Pencillium roqueforti and Penicillium candidum and Torulopsis species. Useful probiotically active organisms also include yeast species such as Saccaromyces cerevisiae, Saccaromyces boulardii, Saccaromyces carlbergensis and Saccaromyces kefir.

In preferred embodiments of the present invention, the bacterial species is selected from the group consisting of the genera Lactobacillus, Bifidobacterium, Bacteroides, Clostridium, Fusobacterium, Melissococcus, Propionibacterium, Streptococcus, Enterococcus, Lactococcus, Staphylococcus, Peptostrepococcus, Bacillus, Pediococcus, Micrococcus, Leuconostoc, Weissella, Aerococcus and Oenococcus. Specific examples of useful lactic acid bacterial species include Lactobacillus johnsonii, Lactobacillus crispatus, Lactobacillus gasseri, Lactobacillus casei, Lactocoocus lactis subsp. cremoris, Lactobacillus paracasei subsp. paracasei, Lactobacillus rhamnosus, Lactobacillus reuteri, Lactobacillus plantarum, Lactobacillus acidophilus, Lactobacillus alimentarius, Lactobacillus casei subsp. casei, Lactobacillus casei Shirota, Lactobacillus curvatus, Lactobacillus delbruckii subsp. lactis, Lactobacillus farciminus, Lactobacillus helveticus, Lactobacillus sake, Lactococcus lactis, Enterococcus faecium, Enterococcus faecalis, Streptococcus salivarius, Streptococcus faecalis and Streptococcus thermophilus.

Useful Bifidobacterium species include Bifidobacterium infantis, Bifidobacterium adolescentis, Bifidobacterium bifidum, Bifidobacterium longum, Bifidobacterium lactis, Bifidobacterium animalis and Bifidobacterium breve.

Further bacterial species which are useful in the present invention can be selected from the group consisting of Bacillus coagulans, Bacillus licheniformis, Bacillus subtilis, Micrococcus varians, Pediococcus acidilactici, Pediococcus pentosaceus, Pediococcus acidilactici, Pediococcus halophilus, Staphylococcus carnosus and Staphylococcus xylosus.

The invention is not, however, limited to these particular micro-organisms. The person skilled in the art would understand and recognise those micro-organisms which may be useful in the method according of the invention. Furthermore, the present invention comprises the use of a combination of two or more of the probiotically active organisms, such as e.g. a preparation comprising a Lactobacillus species and a Bifidobacterium species.

It will be appreciated that a useful probiotically active organisms can be a genetically modified strain of one of the above organisms or any other organism useful in the method of the invention. It will be appreciated that the term “genetically modified” as used herein indicates any modification of DNA sequences coding for genes which e.g. confers resistance to gastric acid and/or antibiotics and modifications of sequences that regulate the expression of genes coding for the capability of the probiotically active organism to adhere to the mucosa of the gastrointestinal tract. Accordingly, genetic modification can be based on construction or selection of mutants of micro-organism or it can be based on recombinant DNA technology.

As used herein the term “mutant” is used in the conventional meaning of that term i.e. it 30 refers to strains obtained by subjecting a microbial strain to any conventionally used mutagenization treatment including treatment with a chemical mutagen such as e.g. ethane-methane sulphonate (EMS) or N-methyl-N′-nitro-N-nitroguanidine (NTG), UV light or to spontaneously occurring mutants which are selected on the basis of a desired characteristic such has antibiotic and/or gastric acid-resistance. It is also possible to provide the genetically modified organism useful in the method according to the invention by random mutagenesis or by selection of spontaneously occurring mutants, i.e. without the use of recombinant DNA technology, conferring resistance to antibiotics and/or gastric acid. It is envisaged that mutants of the above-mentioned organisms also can be provided by recombinant DNA technology including site-directed mutagenesis, PCR techniques and other in vitro or in vivo modifications and insertion of DNA sequences coding for antibiotic resistance and/or gastric acid resistance once such sequences have been identified and isolated.

In accordance with the present method, the medicament and the probiotic may be administered as a combined preparation in form of kits-of-parts or as a single pharmaceutical composition. In a preferred embodiment of the present invention the medicament and the organism are encapsulated in a pharmaceutically acceptable carrier to enhance the survival of the organism in the gastrointestinal tract.

As used herein, the term “pharmaceutically acceptable carrier” means one or more compatible solids or liquid filler diluents or encapsulating substances which are suitable for administration to a human or an animal. The term “compatible” relates to components of the pharmaceutical composition which are capable of being commingled with the medicament and the probiotic, and with each other, in a manner so that there is no interaction which would substantially reduce the pharmaceutical efficacy of the medicament and the probiotic. Pharmaceutically acceptable carriers must be of a sufficiently high purity and a sufficiently low toxicity to render them suitable for administration to humans and animals under treatment. Preferably, such carriers are substantially gastric acid-resistant in order to increase the survival and viability of the probiotically active organism.

Some examples of substances which may serve as pharmaceutically acceptable carriers are sugars such as lactose, glucose and sucrose, starches such as corn starch and potato starch, gums, cellulose and its derivatives such as sodium carboxymethylcellulose, ethylcellulose, cellulose acetate, powdered tragacanth, malt, gelatine, talc, silica, stearic acid, magnesium stearate, calcium sulfate, vegetable oils such as peanut oil, cottonseed oil, sesame oil, olive oil, corn oil and oil of theobroma, polyois such as propylene glycol, glycerine, sorbitol, mannitol, and polyethylene glycol, agar, alginic acid, pyrogen free water, isotonic saline and phosphate buffer solutions, as well as other non-toxic compatible substances used in pharmaceutical formulations. Wetting agents and lubricants such as sodium lauryl sulfate, as well as coloring agents, flavouring agents, excipients, tableting agents, stabilisers, anti-oxidants and preservatives can also be present.

As mentioned above, it may be desirable to provide the medicament and the probiotically active organism in the form of other oral dosage forms such as solid forms including capsules, tablets, granules, bulk powders or in a dried form, such as a freeze-dried or spray-dried form, or as a spore form for organisms which form spores. A review of conventional formulation techniques can be found in e.g. “The Theory and Practice of Industrial Pharmacy” (Ed. Lachman L. et al, 1986) or Laulund (1994). Thus, the tablets may be prepared by methods known in the art and can be compressed, enterically coated, sugar coated, film coated or multiply compressed, containing suitable binders, lubricants, diluents, disintegrating agents, coloring agents, flouring agents, flow-inducing agents and melting agents. Optionally, the medicament and the probiotically active organism may be mixed and a tablet may be prepared by direct compression of such a mixture.

Capsules, both soft and hard capsules, having liquid or solid contents, may be prepared according to conventional techniques well known in the pharmaceutical industry. Thus, for example, the medicament and the probiotically active organism may be mixed together, and if desired, further mixed with suitable excipients, and filled into e.g. gelatine capsules. Optionally, the capsule may be divided into two or more independent sub-capsules, each sub-capsule containing a composition of the medicament or the probiotically active organism. The preparation of such capsules, also known as “tablet in tablet” preparations is well known in the pharmaceutical industry.

It may also be convenient to formulate the preparations in liquid oral dosages such as aqueous solutions, emulsions, suspensions, solutions and/or suspensions reconstituted from non-effervescent granules and effervescent preparations reconstituted from effervescent granules containing suitable solvents, preservatives, emulsifying agents, suspending agents, diluents, sweeteners, melting agents, coloring agents and flavouring agents. The liquid oral dosage form can further be in a form of a fermented dairy product such as yoghurt or sweet acidophilus, comprising viable cells of the probiotically active organism.

The viable cell counts of a probiotic strain in a final preparation, such as e.g. in micro-encapsulated product or tablet, may be of the order 10⁸-10¹² viable microorganisms per gram. In general terms, the probiotic micro-organisms may conveniently be included with the preparation at a ratio of about 10² colony forming units (cfus) per g carrier or more, preferably about 10⁵ cfus or more, most preferably about 10⁷ or more. As a maximum, generally not more than about 10¹² cfus per gram carrier substance will normally be used.

In a highly convenient embodiment of the present method, the combined preparation comprise, by weight, from about 0,1% to about 99,9% of the medicament, preferably from about 0,1% to about 75%, and most preferably from about 1% to about 50%. In a preferred embodiment, the preparation typically comprise, by weight, from about 0,1% to about 99,9% of probiotics, preferably from about 0,1% to about 75%, and most preferably from about 1% to about 50%. An important feature of the present invention is that the dosages of the medicament and the probiotically active organism can be adjusted, harmonised and co-ordinated in order to obtain the optimum reduction of the occurrence of an ecologically adverse change of the composition of the microbial flora in an animal caused by treatment with the medicament.

In accordance with the present invention, the medicament may conveniently be administered at doses within the normal dosage range at which the compound(s) are therapeutically effective, or at higher doses as required. Anti-microbial agents may usually be administered to a human subject in an amount of from about 1 mg to about 10,000 mg of anti-microbial agent per day. The specific preferred quantity of anti-microbial depends upon the particular anti-microbial used and its pharmacology. In general and as an example, though, the tetracyclines are preferably administered at a level of from about 100 mg to about 2,000 mg per day. Penicillins are preferably administered at a level of from about 500 mg to about 3,000 mg per day. The aminoglycosides are, preferably, administered at a level of from about 100 mg to about 8,000 mg per day.

In preferred embodiments, the dosage of the gastric acid-reducing medicament typically involves administering the medicament in an amount of from about 1 mg to about 10 g per day. Preferably from about 50 mg to about 5000 mg, more preferably from about 100 mg to about 1500 mg, most preferably from about 400 mg to about 1200 mg gastric acid-reducing medicament is administered per day.

For the method of the present invention, the duration of administration of the product during either simultaneous, separate or sequential use is to vary according to the specific disease and/or gastrointestinal disorder being treated, but is typically within the range of from about 1 to about 60 days. In general, however, in methods for treatment of non-ulcerative gastrointestinal disorders the duration of treatment comprises administering the agents for from about 3 to about 21 days. In methods for treatment of peptic ulcer disease, the duration of treatment comprises administering the agents for from about 14 to about 56 days.

It is also within the scope of the invention to provide a method of reducing the occurrence of an ecologically adverse change of the composition of the microbial flora in an animal caused by treatment with a gastric acid-reducing medicament, the method comprising administering, in association with the administration of the medicament an effective amount of a probiotically active organism.

In preferred embodiments, the gastric acid reducing medicament is selected from the group consisting of an antacid, a histamine H₂ receptor blocking agent, an anticholinergic compound, a proton pump inhibiting compound and a prostaglandin. Commercial products for reducing gastric acid and useful in the method according to the invention are mentioned above.

In one further embodiment, the probiotically active organism is selected from the group consisting of a fungal species, a yeast species and a bacterial species including lactic acid bacteria, a Bifidobacterium species and a combination thereof. The above range of organisms is also useful as guidelines in the method according to the invention.

The present invention relates in a yet further aspect to the use of a probiotically active organism in the manufacturing of a product for use in a method of reducing the occurrence of an ecologically adverse change of the composition of the microbial flora in an animal caused by treatment with a medicament, said method comprising administering, in association with the administration of the medicament an effective amount of the probiotically active organism, the product comprising the medicament and the probiotically active organism as a combined preparation for simultaneous, separate or sequential use for reducing the occurrence of said ecologically adverse changes of the microbial flora.

In an important embodiment of the present invention, the medicament is a gastric acid reducing medicament selected from the group consisting of an antacid, a histamine H₂ receptor blocking agent, an anticholinergic compound, a proton pump inhibiting compound and a prostaglandin.

In one specific embodiment, the medicament causing the ecologically adverse change of the composition of the intestinal microbial flora is an anti-microbial agent. Such anti-microbial agent may be selected from the group consisting of a β-lactam, a penicillin, a cefalosporine, a monobactame, a carbapeneme, a macrolidantibiotic, a polymyxin, a tetracycline, a chloramphenicol, a aminoglycosid, a fluorquinolone, fusidin, clindamycin, teicoplanin, vancomycin and rifampicin.

In an interesting embodiment, the medicament is a compound as mentioned above that has a regulatory effect upon the digestion.

As mentioned above, it is an objective of the present invention to provide a commercial package unit containing both the medicament and the probiotically active organism, said package being convenient for the patient as the invention makes it possible to bring to the market the medicament and the probiotically active organism at the same time in one package in adjusted, harmonised and coordinated dosages. Accordingly, as a yet further important aspect, the present invention discloses a product comprising a medicament and a probiotically active organism as a combined preparation for simultaneous, separate or sequential use for reducing the occurrence of ecologically adverse changes of the microbial flora in an animal caused by treatment with the medicament.

In selected embodiments, the medicament is a gastric acid reducing medicament, selected from the group consisting of an antacid, a histamine H₂ receptor blocking agent, an anticholinergic compound, a proton pump inhibiting compound and a prostaglandin.

In one specific embodiment, the medicament causing the ecologically adverse change of the composition of the intestinal microbial flora is an anti-microbial agent. Such an antimicrobial agent may be selected from the group consisting of a β-lactam, a penicillin, a cefalosporine, a monobactame, a carbapeneme, a macrolidantibiotic, a polymyxine, a tetracycline, a chloramphenicol, a aminoglycosid, a fluorquinolone, fusidin, clindamycin, teicoplanin, vancomycin and rifampicin.

In an interesting embodiment, the medicament is a compound that has a regulatory effect upon the digestion.

As described above, the medicament and the probiotic can conveniently be provided separately as kits-of-parts in form of capsules, tablets, liquids, bulk powders or granulates. Thus, in an important embodiment of the present invention, the medicament and the probiotically active organism are provided as separate parts.

### EXAMPLES

### Example 1

### Example of Capsules Containing Viable Probiotically Active Micro-organisms in a Matrix Which is Resistant to Gastric Acid

TREVIS® is a commercial product comprising capsules containing the viable microorganisms Lactobacillus acidophilus, Bifidobacterium lactis, Lactobacillus bulgaricus and Streptococcus thermophilus in a matrix which is resistant to gastric acid. The contents of TREVIS® capsules are in the form of a gastric resistant powder containing concentrated freeze dried lactic acid bacteria. To the concentrates are added inactive ingredients, cryoprotectants, to protect the lactic acid bacteria during the freeze drying process of concentrates, and a gelforming polysaccharide, sodium polysaccharide.

### Preparation of the Capsules

### Mixing of a Powder that Contains Probiotically Active Strains

The active ingredients in TREVIS® capsules are: Lactobacillus acidophilus (La-5), Bifidobacterium lactis (Bb-12.17a), Lactobacillus delbrueckii subsp. bulgaricus (Lb-Y27) and Streptococcus thermophilus (St-Y31). The powder contains L. acidophilus, B. lactis, S. thermophilus and L. bulgaricus in the ratio approximately 42:42:11:5 (a total of min. 1-10×10⁹ CFU/capsule).

The concentrated and freeze-dried La-5, Bb-12.17a, Lb-Y27 and St-Y31 pellets are ground (max. particle size 1.35 mm) and mixed with anhydrous dextrose and magnesium stearate in a vertical mixer. During the process the weight of ingredients and mixing time are registered. The mixture, internally called HP-powder, is put into alu foil bags of 5 kg. From each batch 11 samples is taken at random and controlled for total cell count and contaminants. This control is considered a suitable documentation that homogenicity within the batch has been achieved.

### Capsule Filling

HP powder is filled into hard gelatine with titanium oxide colorant capsules using an automatic capsule filling and closing machine. One empty capsule weighs on an average 50 mg, and the capsule contents have a mass of 180 mg.

The relative humidity is kept as low as possible during the process due to the very hygroscopic and water sensitive bacteria. During the mixing process RH in the room is kept at 33% at 21° C. and during the filling process RH in the room is kept less than 40% at 24° C. During the filling of capsules in aluminium tubes the relative humidity of the air in the room is kept at max 40% RH at 24° C. The control of relative humidity helps to acquire a product of consistent quality and increases the stability of the product, as lower humidity inside the capsules is the result.

### Example 2

### Study of the Acid Tolerance of Capsules Containing Viable Probiotically Active Organisms

The objective of this study was to demonstrate the acid tolerance of lactic acid bacteria (LAB) in the matrix of gastric acid-resistant sodium polysaccharide.

### Methods and Materials

### Preparation

The following preparation were used in this study:

1. TREVIS® capsules (of Example 1)

2. Capsules containing Lactobacillus acidophilus strain (La-5) and Bifidobacterium lactis strain Bb-12a

### Test for Acid Tolerance

Acid tolerance was tested under the following conditions:

Test I: survival of LAB in unprotected and protected formulation 2 after 1 h at pH 1.4 and pH 1.7;

Test II: survival of LAB in protected formulation 2 after 1 hour and 2 hours at different pH;

Test III: survival of LAB in protected formulation 1 mixed with different excipients and different filling degree in capsules.

Plate count method were used for determination of total cell count of lactic acid bacteria in the above three tests.

### Conclusions

The formulation principle with sodium polysaccharide matrix improves the acid tolerance of LAB to a survival of LAB of more than 10% of the initial strength which is acceptable considering the very high initial strength of LAB. Survival of LAB increased with higher pH up to about pH 2, from where the survival of LAB seems to stabilise.

### Example 3

### Study on the Recovery of Ingested, Encapsulated Lactobacillus Acidophilus and Bifidobacterium bifidium from Duodenal Fluid and Faeces

The objective of this study was to evaluate the ability of encapsulated lactic acid bacteria to survive the passage through the gastric acidity and thus to enable the bacteria to start a colonisation in the intestine of humans.

### Material and Methods

Capsules containing 16×10⁸ L. acidophilus and 24×10⁸ B. bifidum were used in this study. 1 capsule was administered to 4 volunteers 3 times daily at each meal. L. acidophilus were counted on the Mann Rogosa and Sharpe (MSR) agar, B. bifidum on MRS supplemented with lithium chloride, nalidixic acid and neomycin sulphate and coliforms on violet red bile agar (VRBA).

### Conclusions

The study demonstrated that LAB prepared in an acid-resistant matrix survived passage through the stomach in fasting volunteers. The LAB could be aspirated from duodenum from 30 to 60 min after ingestion. When the last sample was aspirated 3 hours later the concentration of L. acidophilus had decreased, while the B. bifidum counts in the individuals were at the same level. The total number of lactobacilli entering the small intestine is unknown. The aspirate sample can only be locked upon as discrete values from an area with much passage. The statistically significant increase in cell count for B. bifidum was expected as result of B. bifidum ability to adhere and colonize.

### Example 4

### In-vitro Inhibition Trial to Study the Antagonistic Effect of Probiotically Active Micro-organism Towards Toxin-producing Micro-organisms

The objective of this study was to examine the antagonistic effect towards toxin-producing E. coli of a number of lactic acid bacteria.

### Material and Methods

The following test media were used: 10% NFMS (non-fat milk solids)+0.5% peptone P, pH=6.6. 2 ml totally (1%) of one or more probiotic strains and 10⁴ cfus pr. ml of a E. coil strain are added to 200 ml of test medium. 200 ml of the test medium was inoculated with 10⁴ cfus pr. ml of E. coli are used as control. Thereafter incubation in shaking water bath at 36° C. for 6 hours.

The following strains were used in this study, both alone and in combinations:

Bifididobacterium bifidum strain Bb-11 and Bb-12

Streptococcus faecium strain SF68

Streptococcus thermophilus strain CH-2

Lactobacillus acidophillus strain La CH-5

Lactobacillus acidophillus strain La NCDO 1748

Lactobacillus acidophillus strain La MkI

Lactobacillus acidophillus strain La-CH-2

Lactobacillus acidophillus strain Yoghurt CH-1

E. coli—cell counts were made on VRB with top agar. At the beginning of the trial (t=0) counting of cells is made for control, and at the end of the trial (t=6) counting of cells is made on all associative cultures.

### Conclusions

L. acidophillus (LaCH-5) appears to have the smallest effect toward the 5 E. coli strains, whereas Str. thermophilus alone or combined with L. bulgaricus appears to have a strong inhibitory effect toward the 5 E. coli strains. Str. faecium (strain SF68) appears to have the smallest effect toward all 5 strains. The LaCH-5+Bb-12 combination proves to have an inhibitory effect from 0 to 99.2%.

### Example 5

### In-vitro Inhibition Trial to Study the Antagonistic Effect of Probiotically Active Micro-organism Towards Klebsiella and Pseudomonas

The objective of this study was to demonstrate the inhibitory effect of the four strains L. acidophilus, L. bulgaricus, S. thermophilus and Bifidobacteria towards enterotoxic E. coli (ETEC) with the effect towards Klebsiella and Pseudomonas

### Material and Methods

The following test media were used: 10% NFMS (non-fat milk solids)+0.5% peptone P, pH=6.6. 2 ml totally (1%) of one or more probiotic strains and 10⁴ pr. ml of a E. coli strain are added to 200 ml of test medium. 200 ml of the test medium was inoculated with 10⁴ pr. ml of E. coli are used as control. Thereafter incubation in shaking water bath at 36° C. for 6 hours.

The following strains were used in this study, both alone and in combinations:

Bifididobacterium bifidum strain Bb-12

Streptococcus thermophilus strain H30

Lactobacillus acidophillus strain La CH-5

Lactobacillus acidophillus strain La-CH-2

After 6 hours incubation the coliforms and the cell counts of Klebsiella and Pseudomonas were determined.

### Conclusion

The combination of L. acidophilus, B. animalis, L. bulgaricus and S. thermophilus resulted in 99% inhibition of Klebsiella and Pseudomonas strains.

### References

Black, F. T., Andersen, P. L., Ørskov, J., Ørskov, F., Gaarslev, K. & Laulund, S. 1989. Prophylactic efficacy of lactobacilli on traveller's diarrhea. In: Travel Medicine, pp. 333-335. Springer-Verlag Berlin Heidelberg.

Black, F., Einarsson, K., Lidbeck, A., Orrhage, K. & Nord, C. E. 1991. Effect of lactic acid producing bacteria on the human intestinal microflora during ampicillin treatment. Scand. J. Infect. Dis. 23:247-254.

Fekety, F R. 1968. Gastrointestinal complication of antibotic therapy, J. Am. Med Assoc. 203:210-212.

Fuller, 1989. Probiotics in Man and Animals. J Appl. Bacteriol. 66:365-365-378.

Fuller, 1994. Probiotics: an Overview. In Human Heath: The contribution of microorganism. pp. 63-75. Stewart A. W. Gibson (Ed.), Springer-Verlag. London. 1994.

Gotz, V., Romankiewicz, J. A. , Moss, J. & Murray, H. W. 1979. Prophylaxis against ampicillin-associated diarrhea with a lactobacillus preparation. Am J Hosp Pharm 36:754-757.

Laulund, S. (1994). Commercial aspects of formulation, production and marketing of probiotic products. In: Human Heath: The contribution of microorganism. pp.158-173. Stewart A. W. Gibson (Ed.), Springer-Verlag. London. 1994.

Marshall, B. J. & Warren, J. R. 1984. Unidentified curved bacilli in the stomach of patients with gastritis and peptic ulceration. The Lancet, June 16, pp.1311-1315.

McLean, A. J., Harrison, P. M., Joannides-Demos, L. L., Byrne, A. J., McCarthy, P. & Dudley, F. J. 1984. Microbes, peptic ulcer and relapse rates with different drugs. The Lancet, Sep. 1, pp. 525-526.

Orrhage, K, Brismar, B. & Nord, C. E. 1994. Effect of supplements with Bifidobacterium longum and Lactobacillus acidophilus on the intestinal microbiota during administration of Clindamycin. Microbial ecology in health and disease, 7:17-25.

Salminen, S. J., Gorach, S. & Vapaatalo, H. 1989. Faecal colonisation by Lactobacillus GG during antibiotic therapy. Proc. Nutr. Soc. Aust. 14:132.

Smith, 1975. Antibiotic-induced diarrhea. Drugs. 10:329-332.

The Theory and Practice of Industrial Pharmacy”. 1986. Ed. Lachman L. et al, Third Edition, Lea & Febiger, Philadelphia.

1. A method of reducing an occurrence of an ecologically adverse change of a composition of microbial flora in an animal caused by treatment with a medicament, the method comprising administering a preparation comprising an effective amount of at least one probiotically active organism and the medicament, wherein said preparation is for simultaneous, separate or sequential use for reducing the occurrence of said ecologically adverse change of the microbial flora.

2. A method of claim 1, wherein the medicament causing the ecologically adverse change of the composition of microbial flora is a gastric acid-reducing medicament.

3. A method of claim 2, wherein the gastric acid reducing medicament comprises an antacid, a histamine H₂ receptor blocking agent, an anticholinergic compound, a proton pump inhibiting compound or a prostaglandin.

4. A method of claim 1, wherein the medicament causing the ecologically adverse change of the composition of microbial flora is an anti-microbial agent.

5. A method of claim 1, wherein the medicament causing the ecologically adverse change of the composition of microbial flora is a compound that has a regulatory effect upon the digestion.

6. A method of claim 1, wherein the at least one probiotically active organism comprises a fungal species or a bacterial species.

7. A method of claim 6, wherein the bacterial species comprises a lactic acid bacterial species, a Bifidobacterium species or a combination thereof.

8. A method of claim 6, wherein the at least one probiotically active organism comprises a yeast species.

9. A method of claim 1, wherein the preparation comprises the medicament and the at least one probiotically active organism as separate parts.

10. A method of reducing an occurrence of an ecologically adverse change of a composition of microbial flora in an animal caused by treatment with a gastric acid-reducing medicament, the method comprising administering the gastric acid-reducing medicament and an effective amount of at least one probiotically active organism.

11. A method of claim 10, wherein the gastric acid-reducing medicament comprises an antacid, a histamine H₂ receptor blocking agent, an anticholinergic compound, a proton pump inhibiting compound or a prostaglandin.

12. A method of claim 10, wherein the at least one probiotically active organism comprises a fungal species, a bacterial species or a yeast species.

13. A method of claim 12, wherein the bacterial species comprises a lactic acid bacterial species, a Bifidobacterium species or a combination thereof.

14. A composition comprising a medicament and at least one probiotically active organism as a combined preparation for simultaneous, separate or sequential use for reducing the occurrence of ecologically adverse changes of microbial flora in an animal caused by treatment with the medicament.

15. A composition of claim 14, wherein the medicament is a gastric acid reducing medicament.

16. A composition of claim 15, wherein the gastric acid reducing medicament comprises an antacid, a histamine H₂ receptor blocking agent, an anticholinergic compound, a proton pump inhibiting compound or a prostaglandin.

17. A composition of claim 14, wherein the medicament is an anti-microbial agent.

18. A composition of claim 14, wherein the medicament is a compound that has a regulatory effect upon the digestion.

19. A composition of claim 14, wherein the medicament and the probiotically active organism are separate parts.

20. The method of claim 1, wherein the probiotically active organism is administered simultaneously with the medicament.

21. The method of claim 1, wherein the at least one probiotically active organism is administered separately from the medicament.

22. The method of claim 1, wherein the at least one probiotically active organism is administered sequentially with the medicament.

23. The method of claim 1, wherein the at least one probiotically active organism is administered before the medicament.

24. The method of claim 1, wherein the at least one probiotically active organism is administered after the medicament.

25. The method of claim 21, wherein the at least one probiotically active organism is administered before the medicament.

26. The method of claim 21, wherein the at least one probiotically active organism is administered after the medicament.

27. The method of claim 22, wherein the at least one probiotically active organism is administered before the medicament.

28. The method of claim 22, wherein the at least one probiotically active organism is administered after the medicament.

29. Use of a probiotically active organism in the manufacturing of a product for use in a method of reducing the occurrence of an ecologically adverse change of the composition of the microbial flora in an animal caused by treatment with a medicament, said method comprising administering, in association with the administration of the medicament an effective amount of one or more probiotically active organisms, the product comprising the medicament and the probiotically active organism o r organisms as a combined preparation for simultaneous, separate or sequential use for reducing the occurrence of said ecologically adverse changes of the microbial flora.
